(19) United States
(12) Patent Application Publication
(10) Pub. No.: US 2010/0138390 A1
(43) Pub. Date: Jun. 3, 2010

(54) Personal information file management tool

(75) Inventors: Katya Lobo, Clarksburg, NJ (US); Douglas J. Bayne, Glen Ridge, NJ (US); Chad Fulgham, Falls Church, VA (US)

Correspondence Address: David C. Lee;C/O Sills, Cummis and Gross, 1 Rockefeller Plaza, New York, NY, 10020, US

(73) Assignee: Barclays Capital Inc., New York, NY (US)

(21) Appl. No.: 12/458,467

(22) Filed: Jul. 13, 2009

Related U.S. Application Data
(60) Provisional application No. 61/080,098, filed on Jul. 11, 2008.

(51) Int. Cl. G06F 17/30

(52) U.S. Cl. 707/640; 707/769; 707/822; 707/E17.108; 707/E17.005; 707/E17.01

(57) ABSTRACT

A system and method provide management of personal information files containing personal contacts, calendars, emails, and the like. A client device is configured to store a personal information file. A personal information file management tool is configured to search a directory on a server. The personal information file management tool compares a contact in the personal information file with the directory and updates the contact in the personal information file with the information in the directory.

This application claims the benefit of the U.S. Provisional Patent Application No. 61/080,098 filed on Jul. 11, 2008, which is hereby incorporated by reference.

### BACKGROUND OF THE INVENTION

1. Field of the Invention

The present invention relates to a personal information file management tool, and more particularly to tools for managing personal information files containing personal contacts, calendars, emails, and the like.

2. Discussion of the Related Art

With the advancements in information technology (“IT”) in the workplace and personal lives, many people have become accustomed to managing their communications, schedules, and contact information on their computers, personal digital assistant (“PDA”) devices, cell phones, and other digital devices with organizing functions. These digital personal organizer applications typically include the ability to send/receive emails and other digital content, collect/manage contact information, and create/manage schedules in some form of electronic calendar. After some period of usage, several data management issues begin to surface.

In one aspect, information in the personal contacts may need to be updated with new information as people transition in their workplace, home, and/or service providers (e.g., phone numbers, email addresses, etc.). In some instances, certain personal contacts are rarely, if ever, used. Managing these changes may become cumbersome and difficult, especially in high-volume, high-transitory environments, such as in a workplace.

In another aspect, as data are continuously added, storage space may become a significant issue, especially in a hosted environment in which many users store their data on a hosting server. To find and delete unnecessary files may also be cumbersome and difficult.

To manage storage space, some hosts set limits on the amount of data that can be stored in each file (e.g., .pst file) for each user. In other instances, regardless of file size, some users create additional personal information files to organize and manage their personal information. In general, these personal information files can then be connected/disconnected to hosting servers. A personal information file connected to a hosting server becomes “active,” e.g., new email data, shared contact information such as network contact directories, and shared calendars for scheduling, etc. are stored in the connected personal information file. By contrast, disconnected personal information files are static and serve as archives until reconnected to the hosting server. However, creating/managing these personal information files becomes difficult because the location of these personal information files is not readily apparent, especially when created on a hosting server (e.g., name of the server, directory, folder, etc.). Furthermore, because these personal information files can be created at-will, users may end up creating multiple files unnecessarily, especially if the user cannot find one that was already created, thereby taking up storage capacity unnecessarily.

### SUMMARY OF THE INVENTION

Accordingly, the present invention is directed to a personal information file management tool that substantially obviates one or more problems due to limitations and disadvantages of the related art.

An object of the present invention is to provide a personal information file management tool that compares and updates personal contact lists with directory lists and automatically updates contact information and/or identifies contacts that are not found in the directory.

Another object of the present invention is to provide a personal information file management tool that automatically purges files attached to past calendar events to free up storage capacity.

Yet another object of the present invention is to provide a personal information file management tool that regulates and tracks creation of new personal information files.

Still yet another object of the present invention is to provide a personal information file management tool that provides a list of all personal information files associated with a user including status information.

Additional features and advantages of the invention will be set forth in the description which follows, and in part will be apparent from the description, or may be learned by practice of the invention. The objectives and other advantages of the invention will be realized and attained by the structure particularly pointed out in the written description hereof as well as any of the appended drawings herein.

It is to be understood that both the foregoing general description and the following detailed description are exemplary and explanatory and are intended to provide further explanation of the invention.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a system diagram of an exemplary embodiment of the present invention;

FIGS. 2A-2D are exemplary interfaces of the personal information file management tool of the present invention;

FIGS. 3A-3D are exemplary interfaces of the personal information file management tool of the present invention;

FIGS. 4A-4C are exemplary interfaces of the personal information file management tool of the present invention; and

FIGS. 5A-5B are exemplary interfaces of the personal information file management tool of the present invention.

### DETAILED DESCRIPTION OF THE EXEMPLARY EMBODIMENTS

Reference will now be made in detail to the embodiments of the present invention, examples of which are illustrated in the accompanying drawings.

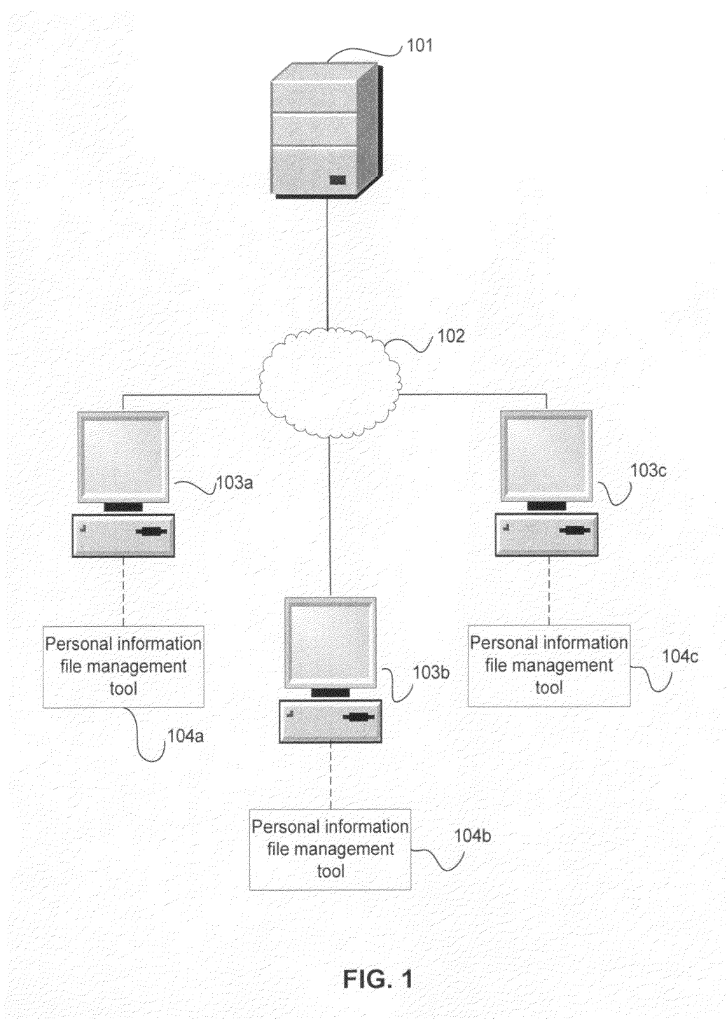

FIG. 1 illustrates a system diagram of an exemplary embodiment of the present invention. As shown in FIG. 1, client devices 103a-103c are in communication with server 101 through a communications network 102. Server 101 may be one or more hosting servers in communication with client devices 103a-103c. Server 101 may be an active directory server, which stores an active directory. Server 101 may also store a database or generic directory rather than an active directory. In addition, other storage devices other than server 101 may be used as are known in the art.

An active directory is a directory structure used on a computer, including server 101, to store information and data about communications network(s) 102 and domains. An active directory may be defined as a hierarchical structure, and this structure may be broken up into three main categories, the resources which might include hardware such as printers, services for end users such as web email servers, and objects. An active directory may do a variety of functions including providing information on objects, resources, and services, organizing these objects, resources, and services for easy retrieval and access, allowing access by end users and administrators, and allowing the administrator to set security up for the directory.

Client devices 103a-103c may be any communication device such as computers, cell phones, personal digital assistants (PDAs), and the like. Client device 103a-103c may be in communication with a personal information file management tool 104a-104b. Personal information file management tool 104a-104b may be software that is stored on client devices 103a-103c and executed by client devices 103a-103c. In the alternative, personal file management tool 104a-104b may be stored on server 101, and sent to or downloaded by client device 103a-103c for execution. Personal information file management tool 104a-104b may store personal information of a client in a personal information file on client devices 103a-103c or remotely on server 101 or other hosting server. Personal information file management tool 104a-104b may be integrated in a client device's email application.

The communications network 102 may be any data communications network, such as point-to-point connection, local area network, wide area network, Intranet, Internet, cellular network, and the like. Client devices 103a-103c are in communication with server 101 to send and receive a client's personal contact information stored in the personal information file and/or other information stored in the personal information file or on server 101.

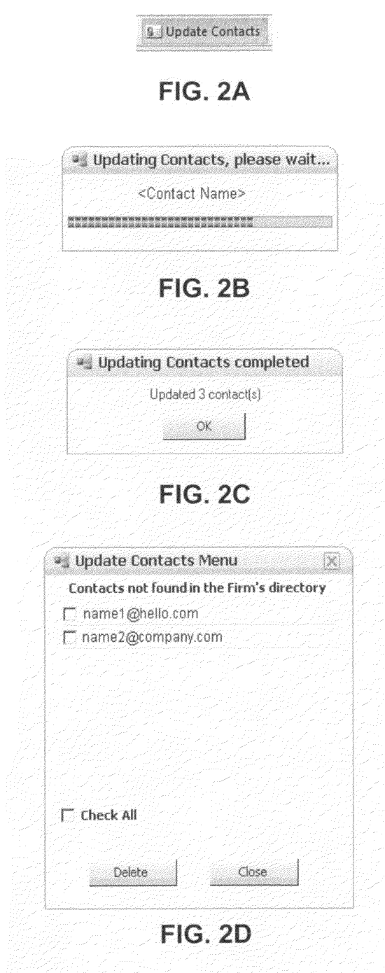

FIGS. 2A-2D are exemplary interfaces of personal information file management tool 104a-104c of the present invention. Personal contacts in a personal information file may become out-dated or out of sync with an active network directory on server 101, such as an organization's directory of employees. Personal information file management tool 104a-104c in accordance with the present invention offers automated synchronization of all contacts with a directory on server 101. For example, personal information file management tool 104a-104c populates and/or overwrites existing fields that pertain to a person in a personal contact list in the personal information file on client computers 103a-103c with the information available in the directory, such as the person's professional information (e.g., position/title, location/office, work phone number, etc.) while leaving the person's identity information (e.g., first/last name) intact.

In an illustrative example, when the directory update is requested by, for example, using the “Update Contacts” feature shown in FIG. 2A, personal information file management tool 104a-104c searches the directory on server 101 against the list of contacts in the personal information file using a root search parameter that uniquely identifies the person (e.g., first name, last name, email address, etc., or any combination thereof). When a match is found, personal information file management tool 104a-104c updates the person's information in the personal information file with the information from the directory (e.g., position/title, location/office, work phone number, etc.). While contacts are being updated, the user is able to see the contact that is currently being accessed by the process as shown in FIG. 2B. As personal information file management tool 104a-104c finishes processing updates, it will display additional information on how many users were updated as shown in FIG. 2C.

If a match is not found in the directory, then personal information file management tool 104a-104c provides a list of contacts that were not found in the directory on server 101 as shown in FIG. 2D. Personal information file management tool 104a-104c may receive from a user any entries of deletions of contacts that may be out of date or unused as shown in FIG. 2D. The personal information file may be updated based on these entries received.

To ensure proper updates, personal information file management tool 104a-104c in accordance with the present invention creates a backup copy of all contact items before they are modified with the information from the directory and stores the backup copy on client devices 103a-103c. Once the contacts have been updated, a record of the updated contacts and a copy of the contact items before modification remain stored on client devices 103a-103c and are retrievable through personal information file management tool 104a-104c or other application.

In this way, personal information file management tool 104a-104c allows for bulk updates of all the contacts in the personal information file while providing a convenient mechanism for cleaning the personal contact list of contacts no longer used or needed. It is to be understood that other parameters may be used for the search criteria and other data fields may be updated in the contact list without departing from the scope of the present invention.

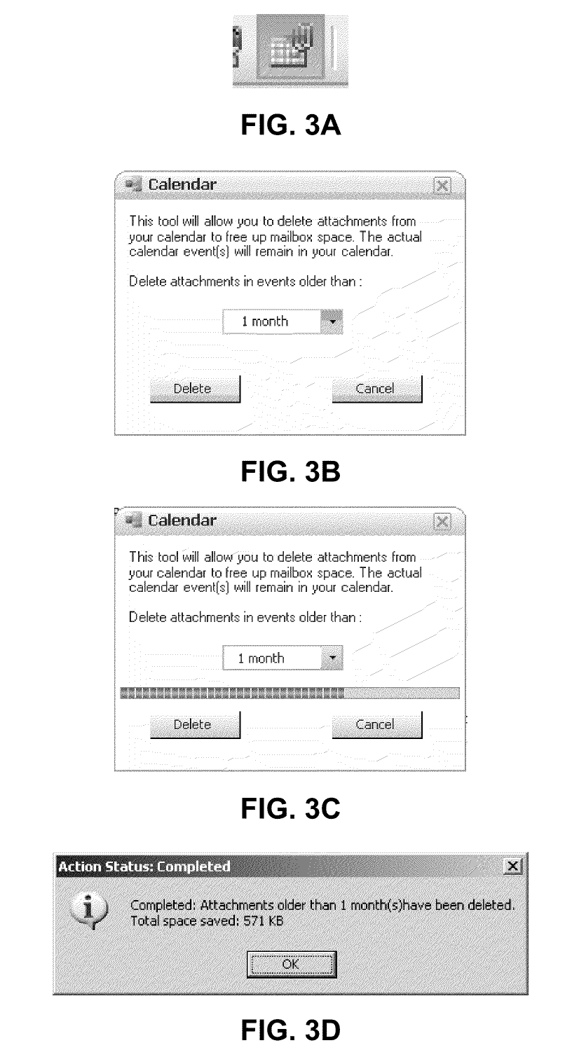

FIGS. 3A-3D are exemplary interfaces of the personal information file management tool of the present invention. A personal information file stored on client devices 103a-103c, or in the alternative, on server 101 or other server, may have size limitations as well as limited storage space. One source of releasing file size and storage limits is to delete attachments to past calendar items. Personal information file management tool 104a-104c in accordance with an exemplary embodiment of the present invention allows a user to automatically analyze past calendar events in the personal information file and delete any attachments associated with the past calendar items. For example, a user may select an option to delete calendar items (FIG. 3A). Personal information file management tool 104a-104c allows the user to specify the time up to which the deletion process will end (e.g., delete all attachments to events older than one (1) month) as shown in FIG. 3B. Personal information file mangament tool 104a-104c analyzes calender items up to the specified period and deletes every attachment associated with calender events before the specified period. Status of the deletions may be displayed in an interface, such as that shown in FIG. 3C. At the end of the deletion process, the user is presented with information on how much storage space was freed for mailbox use as shown in FIG. 3D. In this manner, storage capacity and file size of the personal information file may be managed without complicated review of past items for deletion.

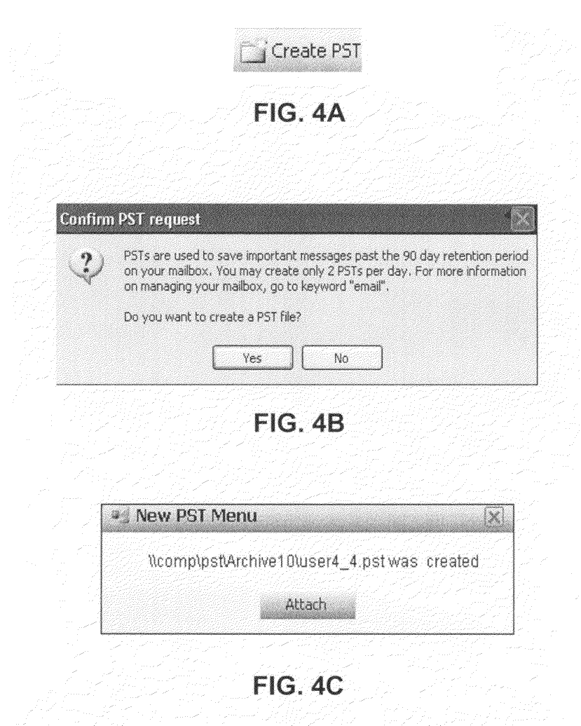

FIGS. 4A-4C are exemplary interfaces of the personal information file management tool of the present invention. In another exemplary embodiment of the present invention, personal information file management tool 104a-104c accommodates users' requests for new personal information files (e.g., .pst files) while providing some control over the creation of the personal information files. FIG. 4A illustrates an option for selection by a user for creating a personal information file. For instance, personal information file management tool 104a-104c may limit the number of personal information files that can be created for a user (e.g., 2 personal information files per user per day) as shown in FIG. 4B. In addition, personal information file management tool 104a-104c keeps a record of the location of each personal information file created for a user as shown in FIG. 4C.

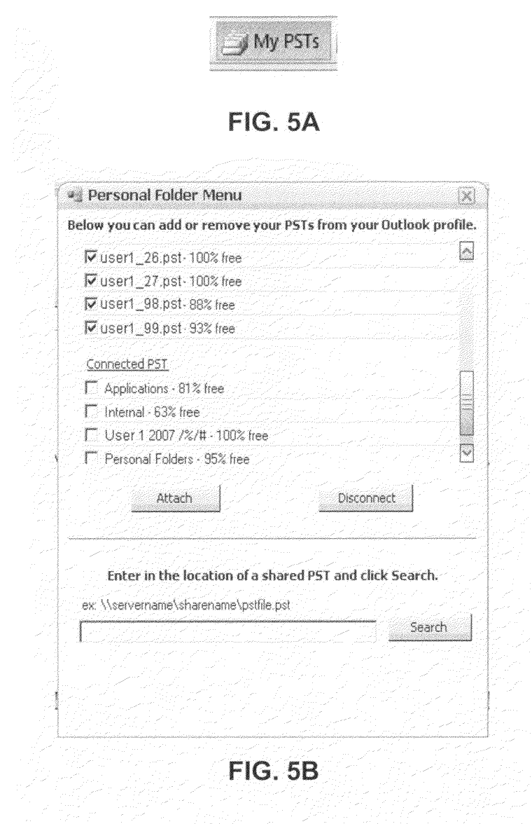

FIGS. 5A-5B are exemplary interfaces of the personal information file management tool of the present invention. Once the personal information files have been created, personal information file management tool 104a-104c in accordance with an exemplary embodiment of the present invention provides the user with the ability to view and manage all of the user's personal information files. For example, a user may select an option, such as that shown in FIG. 5A, to view and manage personal information files.

Personal information file management tool 104a-104c may track the capacity of each personal information file and display the status of each personal information file to the user as shown in FIG. 5B. The status of the personal information file may include the location of the personal information file, the amount of used/free capacity of the file, whether the personal information file is connected/disconnected to the hosting server, etc. For example, a personal information file close to capacity may be shown in red, or other indicators, to signal that the file is nearing capacity. In response to this indication, the user may delete items on client devices 103a-103c (e.g., emails, attachments to calendar items, etc.), create a new personal information file in the manner described above, or select a different existing personal information file in the manner described above. Because the locations of all personal information files are tracked in accordance with the present invention, personal information file management tool 104a-104b allows the user to easily select the personal information file(s) to attach/disconnect from a hosting server or other storage device, such as server 101. In case a personal information file is not shown in the list, the personal information file management tool includes a search engine to search a specified location for a personal information file.

It will be apparent to those skilled in the art that various modifications and variations can be made in the personal information file management tool of the present invention without departing from the spirit or scope of the invention.

1. A method, comprising:
receiving a command to update at least one contact in a personal information file; and
upon receiving the command, performing the following in a single action:
searching a directory on a server, the directory including information of at least one person, the information of the at least one person including an identifier;
comparing the at least one contact in the personal information file with the identifier of the at least one person in the directory;
determining whether the identifier of the at least one person matches the at least one contact in the personal information file; and
if the identifier of the at least one person matches the at least one contact in the personal information file, updating the at least one contact in the personal information file with the information of the at least one person in the directory.

2. The method of claim 1, wherein the information of the at least one person in the directory is one or more of the following: position, title, location, and phone number.

3. The method of claim 1, wherein the identifier includes one or more of the following: first name, last name, and email address.

4. The method of claim 1 further comprising the steps of determining and displaying at least one contact in the personal information file not contained in the directory.

5. The method of claim 4 further comprising deleting the at least one contact in the personal information file not contained in the directory.

6. The method of claim 1 further comprising the step of creating a backup copy of the at least one contact in the personal information file before updating.

7. A system, comprising:
a client device configured to store a personal information file; and
a personal information file management tool configured to receive a command to update at least one contact in a personal information file and upon receiving the command, perform the following in a single action:
search a directory on a server, the directory including information of at least one person, the information of the at least one person including an identifier,
compare the at least one contact in the personal information file with the identifier of the at least one person in the directory,
determine whether the identifier of the at least one person matches the at least one contact in the personal information file, and
if the identifier of the at least one person matches the at least one contact in the personal information file, update the at least one contact in the personal information file with the information of the at least one person in the directory.

8. The system of claim 7, wherein the information of the at least one person in the directory is one or more of the following: position, title, location, and phone number.

9. The system of claim 7, wherein the identifier includes one or more of the following: first name, last name, and email address.

10. The system of claim 7, wherein the personal information file management tool is further configured to determine and display at least one contact in the personal information file not contained in the directory.

11. The system of claim 10, wherein the personal information file management tool is further configured to delete the at least one contact in the personal information file not contained in the directory.

12. The system of claim 7, wherein the personal information file management tool is further configured to create a backup copy of the at least one contact in the personal information file before the update.

13. A computer program product including a computer readable medium having stored thereon computer executable instructions that, when executed by a computer, direct the computer to perform a method comprising the steps of:
receiving a command to update at least one contact in a personal information file; and
upon receiving the command, performing the following in a single action:
searching a directory on a server, the directory including information of at least one person, the information of the at least one person including an identifier;
comparing the at least one contact in the personal information file with the identifier of the at least one person in the directory;
determining whether the identifier of the at least one person matches the at least one contact in the personal information file; and
if the identifier of the at least one person matches the at least one contact in the personal information file, updating the at least one contact in the personal information file with the information of the at least one person in the directory.

14. The computer program product of claim 13, wherein the information of the at least one person in the directory is one or more of the following: position, title, location, and phone number.

15. The computer program product of claim 13, wherein the identifier includes one or more of the following: first name, last name, and email address.

16. The computer program product of claim 13 further including computer executable instructions that, when executed by the computer, configure the computer to perform the steps of determining and displaying at least one contact in the personal information file not contained in the directory.

17. The computer program product of claim 16 further including computer executable instructions that, when executed by the computer, configure the computer to perform the step of deleting the at least one contact in the personal information file not contained in the directory.

18. The computer program product of claim 13 further including computer executable instructions that, when executed by the computer, configure the computer to perform the step of creating a backup copy of the at least one contact in the personal information file before updating.

19. A method, comprising:
storing a personal information file on a client device;
analyzing at least one event in the personal information file based on a time of the at least one event; and
deleting an attachment associated with the at least one event in the personal information file if the time of the at least one event occurred before a defined time period.

20. The method of claim 19, wherein the at least one event is a calendar event.

21. The method of claim 19 further comprising the step of displaying a status of the deletion of the attachment.

22. The method of claim 21 further comprising the step of displaying an amount of storage space available on the client device after the deletion of the attachment.

23. A system, comprising:
a client device configured to store a personal information file; and
a personal information file management tool configured to analyze at least one event in the personal information file based on a time of the at least one event and delete an attachment associated with the at least one event in the personal information file if the time of the at least one event occurred before a defined time period.

24. The system of claim 23, wherein the at least one event is a calendar event.

25. The system of claim 23, wherein the personal information file management tool is further configured to display a status of the deletion of the attachment.

26. The system of claim 25, wherein the personal information file management tool is further configured to display an amount of storage space available on the client device after the deletion of the attachment.

27. A computer program product including a computer readable medium having stored thereon computer executable instructions that, when executed by a computer, direct the computer to perform a method comprising the steps of:
storing a personal information file on a client device;
analyzing at least one event in the personal information file based on a time of the at least one event; and
deleting an attachment associated with the at least one event in the personal information file if the time of the at least one event occurred before a defined time period.

28. The computer program product of claim 27, wherein the at least one event is a calendar event.

29. The computer program product of claim 27 further including computer executable instructions that, when executed by the computer, configure the computer to perform the step of displaying a status of the deletion of the attachment.

30. The computer program product of claim 29 further including computer executable instructions that, when executed by the computer, configure the computer to perform the step of displaying an amount of storage space available on the client device after the deletion of the attachment.

31. A method, comprising:
creating at least one personal information file on a client device;
tracking a capacity of the at least one personal information file; and
displaying a status of the at least one personal information file.

32. The method of claim 31 further comprising the step of selecting the at least one personal information file on the client device to connect to or disconnect from a server.

33. The method of claim 31, wherein the status of the at least one personal information file comprises one or more of the following: location of the personal information file, amount of used capacity of the personal information file, and status of a connection with a server.

34. The method of claim 31 further comprising the step of searching for a personal information file on the client device.

35. A system, comprising:
a client device configured to create at least one personal information file; and
a personal information file management tool configured to track a capacity of the at least one personal information file and display a status of the at least one personal information file on the client device.

36. The system of claim 35, wherein the personal information file management tool is further configured to select the at least one personal information file on the client device to connect to or disconnect from a server.

37. The system of claim 35, wherein the status of the at least one personal information file comprises one or more of the following: location of the personal information file, amount of used capacity of the personal information file, and status of a connection with a server.

38. The system of claim 35, wherein the personal information file management tool is further configured to search for a personal information file on the client device.

39. A computer program product including a computer readable medium having stored thereon computer executable instructions that, when executed by a computer, direct the computer to perform a method comprising the steps of:
creating at least one personal information file on a client device;
tracking a capacity of the at least one personal information file; and
displaying a status of the at least one personal information file.

40. The computer program product of claim 39 further including computer executable instructions that, when executed by the computer, configure the computer to perform the step of selecting the at least one personal information file on the client device to connect to or disconnect from a server.

41. The computer program product of claim 39, wherein the status of the at least one personal information file comprises one or more of the following: location of the personal information file, amount of used capacity of the personal information file, and status of a connection with a server.

42. The computer program product of claim 39 further including computer executable instructions that, when executed by the computer, configure the computer to perform the step of searching for a personal information file on the client device.
